(19) United States
(12) Patent Application Publication
(10) Pub. No.: US 2011/0159137 A1
(43) Pub. Date: Jun. 30, 2011

(54) TABLET COMPRESSION DIE

(76) Inventors: Shinji Ando, Tokyo (JP); Kenji Yoshida, Tokyo (JP)

(21) Appl. No.: 13/062,415

(22) PCT Filed: Sep. 7, 2009
(86) PCT No.: PCT/JP2009/065581

§ 371 Date: Mar. 4, 2011

(30) Foreign Application Priority Data
Sep. 8, 2008 (JP) 2008-229574

(51) Int. Cl. B30B 11/02

(52) U.S. Cl. 425/415

(57) ABSTRACT

A tablet compression die configured such that formation of edges on the surface of a tablet is suppressed when the tablet is integrally formed by compression. A tablet compression die is provided with a space (S) into which rods (3, 4) having pressing surfaces (13, 14) at the tips thereof are inserted and which extend in the direction of the axis of the rods (3, 4), and the tablet compression die is used to produce the tablet (11) integrally compacted and formed by compressing powder (12) in the space (S) by means of the pressing surfaces (13, 14). A molding groove (6) having a recessed curved surface is annularly formed on the inner peripheral surface of the space (S). The molding groove (6) is integrally connected to the pressing surfaces (13, 14) and forms a part of the surface of the tablet (11) in forming the tablet. The tablet compression die is also provided with a separating mechanism for separating at least a part of a die body (7) so that the tablet (11) engaged with the annular molding groove (6) can be taken out.

### TECHNICAL FIELD

The present invention relates to a tablet compression die used for compressing powder into a solid tablet.

### BACKGROUND ART

A known tablet compression apparatus (tablet compression machine) used for producing a tablet comprises a pair of upper and lower rods having a pressing surface at the tip end and a die (tablet compression die or die for the tablet compression apparatus) having a die cavity (space) that extends in the vertical direction (the direction of the axis of the rods) and is open at the vertical opposite ends so that the rods can be inserted into the die cavity. Powder (tabletting powder) is charged into the die cavity, the tip ends of the pair of upper and lower rods are inserted into the die cavity through the upper and lower open ends thereof, and then, the powder in the space is compressed between the pair of pressing surfaces into a solid tablet (see Japanese Patent Laid-Open Nos. 4-28498, 7-8540, 2002-1593, 2002-103096 and 7-124231, for example).

The tablet compression apparatus configured as described above applies a high force to each rod to achieve tablet compression (tableting). Thus, if the upper and lower rods come into contact with each other at the tip ends during tablet compression, the tip ends of the rods may be damaged or deformed. To avoid such a trouble, the upper and lower rods are configured not to come into contact with each other during tablet compression. In addition, the pressing surfaces at the tip ends of the rods, which are horizontally oriented, and the inner surface of the die cavity, which is vertically oriented, are not seamlessly connected to each other. As a result, an edge (protrusion or recess) is formed on the surface of the tablet by compression along the boundaries between the pressing surfaces of the rods and the inner surface of the die cavity.

The edge on the surface of the tablet is relatively fragile to chipping and may become chipped during film coating to lead a defective tablet. Although the tablet surface can be sugar-coated to cover the edge thereon, the sugar-coated tablet is significantly larger than the tablet without the sugar coating. Thus, this technique is difficult to use for a tablet that has a size restriction.

To overcome these disadvantages, a tablet chamfering technique has been developed and known that produces a tablet without an edge by trimming the edge on the surface of the tablet by compression (see Patent Literatures 1 to 3).

### CITATION LIST

### Patent Literature

Patent Literature 1: Japanese Patent Laid-Open No. 48-99079

Patent Literature 2: Japanese Patent Laid-Open No. 53-19977

Patent Literature 3: Japanese Patent Publication No. 53-47357

### SUMMARY OF INVENTION

### Technical Problem

The techniques disclosed in Patent Literatures described above have problems that the tablet may have a coarse surface because of the trimming and the part trimmed off may have medicinal properties. Thus, there is a demand for a technique that prevents formation of an edge during tablet compression.

An object of the present invention is to solve the problems described above and provide a tablet compression die that prevents formation of an edge on the surface of a solid tablet during tablet compression.

### Solution to Problem

In order to solve the problems described above, in the first place, a tablet compression apparatus according to the present invention is a tablet compression die having a space S extending in an axial direction of rods 3 and 4 into which the rods are inserted, the rods 3 and 4 having pressing surfaces 13 and 14 at a tip end, respectively, and the pressing surfaces 13 and 14 the powder 12 in the space S into a solid tablet 11 by compression, characterized in that an annular concave molding groove 6, which is seamlessly connected to the pressing surfaces 13 and 14 to form a part of the surface of the tablet 11 during tablet compression, is formed in an inner circumference of the space S, and the tablet compression die has a separation mechanism that separates at least a part of a die main body 7 to allow removal of the tablet 11 held in the annular molding groove 6.

In the second place, the tablet compression apparatus is characterized in that the tablet compression die has a die cavity 1 whose inside provides the space S and that is open at opposite ends and extends in the axial direction of the rods 3 and 4 to allow insertion of the pair of rods 3 and 4 through the opposite open ends, and the pressing surfaces 13 and 14 of the pair of rods 3 and 4 and the molding groove 6 are seamlessly connected to each other to form a single circular, elliptical or elongated circular shape in cross-sectional side view during tablet compression.

In the third place, the tablet compression apparatus is characterized in that the tablet compression die has a die hole 21 whose inside provides the space S and that is open at one end to allow insertion of the rod 3 or 4 and defined at the other end by a closed surface 19 or 23 and extends in the axial direction of the rods 3 and 4, and the closed surface 19 or 23, the pressing surface 13 or 14 and the molding groove 6 are seamlessly connected to each other to form a single circular, elliptical or elongated circular shape in cross-sectional side view during tablet compression.

In the fourth place, the tablet compression apparatus is characterized in that the separation mechanism separates the die main body 7 at a plane that extends in the axial directions of the rods 3 and 4 and divides the molding groove 6.

In the fifth place, the tablet compression apparatus is characterized in that the separation mechanism separates the die main body 7 at a plane that extends in a direction perpendicular to the axial directions of the rods 3 and 4 and divides the molding groove 6.

### ADVANTAGEOUS EFFECTS OF INVENTION

The tablet compression die according to the present invention configured as described above has an advantage that formation of an edge on the surface of the tablet is prevented during tablet compression because the annular concave molding groove that is seamlessly connected to the pressing surfaces to form a part of the surface of the tablet during tableting is formed in the inner circumference of the space. In addition, the tablet compression die has an advantage that the tablet can be easily removed because of the separation mechanism that separates at least a part of the die main body so that the tablet held in the annular molding groove can be removed.

### BRIEF DESCRIPTION OF DRAWINGS

FIG. 1(A) is a cross-sectional side view of essential parts of a tablet compression apparatus that includes a tablet compression die according to the present invention, and FIG. 1(B) is a plan view of the die used in the tablet compression apparatus.

FIG. 2 is an exploded side view of the tablet compression apparatus.

FIG. 3 is a cross-sectional side view of essential parts of the tablet compression apparatus during compression molding of a tablet.

FIGS. 4(A) and 4(B) are plan views of tablets having different shapes, and FIGS. 4(C) and 4(D) are cross-sectional side views of essential parts of tablet compression apparatuses that differ in shape of the molding groove and the pressing surface.

FIGS. 5(A) and 5(B) are a plan view and a side view of a tablet having a different shape, respectively.

FIGS. 6(A) to 6(M) are state transition diagrams illustrating a process of molding a solid tablet by compression and removing the tablet by lifting or lowering an upper and an lower rod and a lower die with an upper die fixed.

FIGS. 7(A) to 7(M) are state transition diagrams illustrating a process of molding a solid tablet by compression and removing the tablet by lifting or lowering the upper and lower rods and the upper die with the lower die fixed.

FIGS. 8(A) to 8(D) are state transition diagrams illustrating a process of molding a tablet by compression by charging powder into a space with the upper and lower ends of the space closed with the pair of upper and lower rods, respectively.

FIGS. 9(A) to 9(D) are cross-sectional side views of essential parts of tablet compression apparatuses according to other embodiments of the present invention.

FIGS. 10(A) and 10(B) are a cross-sectional side vide and an exploded cross-sectional front view of essential parts of a tablet compression apparatus according to another embodiment of the present invention, respectively.

FIGS. 11(A) to 11(C) are exploded cross-sectional side views of modifications of the tablet compression apparatus shown in FIG. 10.

FIGS. 12(A) and 12(B) are a cross-sectional side vide and an exploded cross-sectional front view of essential parts of a tablet compression apparatus according to another embodiment of the present invention, respectively.

FIGS. 13(A) to 13(C) are exploded cross-sectional side views of modifications of the tablet compression apparatus shown in FIG. 12.

### REFERENCE SIGNS LIST

1 die cavity
3 upper rod (rod)
4 lower rod (rod)
6 molding groove (rounded annular surface)
7 die main body
11 tablet
12 powder (tabletting powder)
13 pressing surface
14 pressing surface
19 bottom surface (closed surface)
21 die hole
23 top surface (closed surface)
S space

### DESCRIPTION OF EMBODIMENTS

In the following, embodiments of the present invention will be described with regard to examples shown in the drawings.

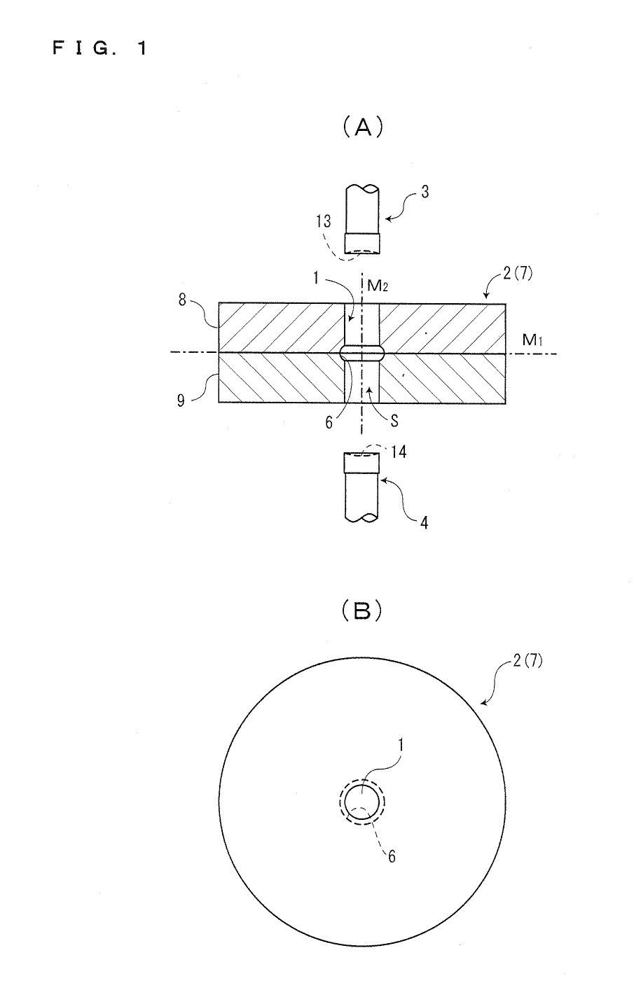

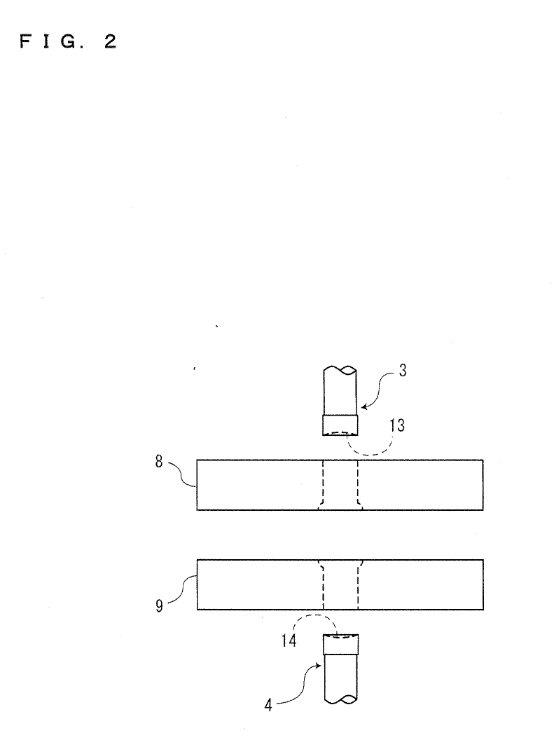

FIG. 1(A) is a cross-sectional side view of essential parts of a tablet compression apparatus that includes a tablet compression die according to the present invention, FIG. 1(B) is a plan view of the die used in the tablet compression apparatus, and FIG. 2 is an exploded side view of the tablet compression apparatus. The tablet compression apparatus comprises a die (tablet compression die or die for the tablet compression apparatus) 2 having the shape of a thick horizontally-oriented plate through which a vertical cylindrical die cavity 1 is formed, and a pair of upper and lower rods 3 and 4 having a cylindrical shape so that the rods can be inserted (fitted) into the die cavity 1 and arranged coaxially with the die cavity 1.

The inside of the die cavity 1 provides a space S into which the upper and lower rods 3 and 4 are inserted from above and below, respectively. A rounded, circular ring-shaped molding groove (rounded annular surface) 6, which has an arc shape in cross-sectional side view, is formed in the inner surface of the space S (die cavity 1) at a vertically middle part thereof along the entire perimeter thereof.

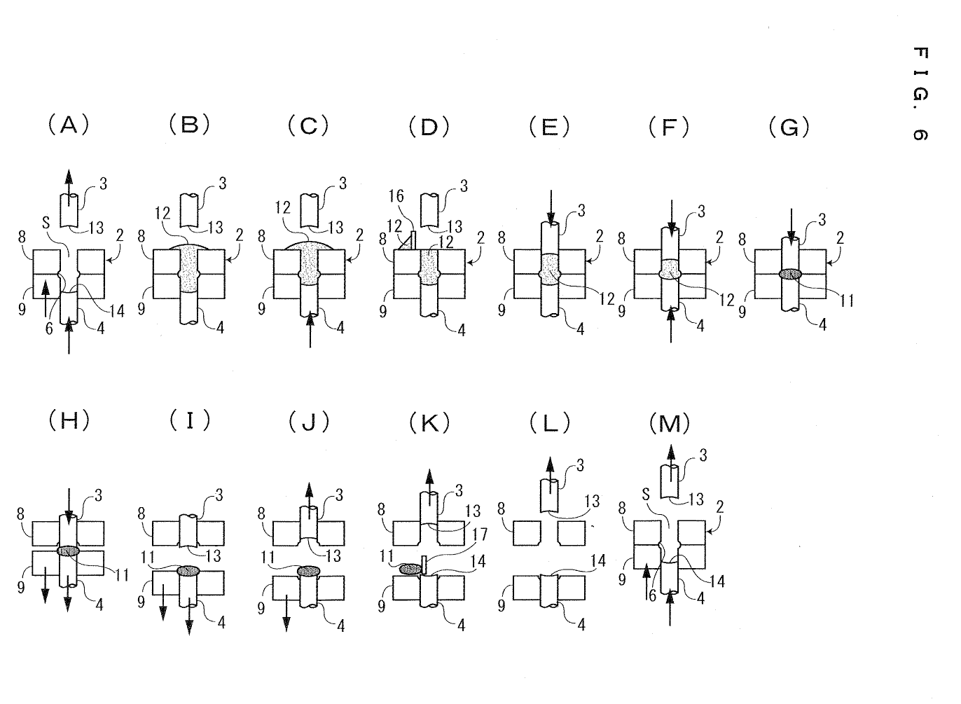

The die 2 described above comprises a disk-shaped die main body 7, through which the die cavity 1 described above is formed. The die main body 7 is divided into upper and lower parts at a horizontal division plane (division plane) M₁, which is a horizontal plane that extends perpendicularly to the axis of the rods 3 and 4 and vertically divides the molding groove 6 into equal upper and lower parts. The die main body 7 is formed by bringing an upper die 8, which is the upper part, and a lower die 9, which is the lower part, into intimate contact with each other. A tablet 11 (see FIG. 6) held in the molding groove 6 can be removed from the space S with means described later by separating the upper die 8 and the lower die 9 to open the space S.

That is, there is provided a separation mechanism that separates at least a part of the die main body 7 (the upper die 8 or the lower die 9 in the illustrated example) to allow easy removal of the tablet 11 held in the molding groove 6.

The upper and lower rods 3 and 4 have a larger outer diameter at the tip end part (the lower end part of the upper rod 3 and the upper end part of the lower rod 4), from which the rods are inserted into the die cavity 1, than at the root part and the middle part thereof, and the outer diameter of the upper and lower rods 3 and 4 is substantially equal to the inner diameter of the space S. The upper and lower rods 3 and 4 are inserted into the space S from above and below, respectively, so that the rods are slidable in the axial direction. The tip end surface of each rod 3, 4 serves as a pressing surface 13, 14 for compressing powder (tabletting powder) 12 charged into the space (see FIG. 6). The pressing surfaces 13 and 14 are concave toward the axis of the rods 3 and 4.

The upper and lower rods 3 and 4 and the upper and lower dies 8 and 9 are separately vertically moved (lifted and lowered) by one or more actuators (driving means), not shown.

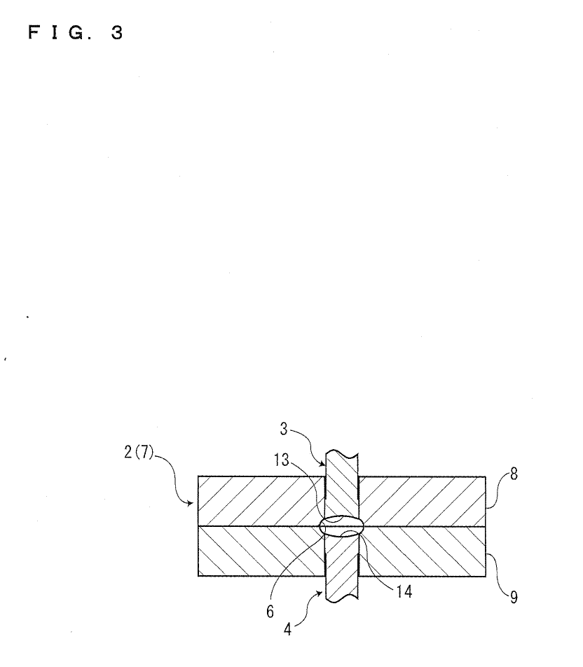

FIG. 3 is a cross-sectional side view of essential parts of the tablet compression apparatus during tablet compression. Once the upper and lower rods 3 and 4 are inserted into the space S from above and below, the tablet compression apparatus slides the rods 3 and 4 to positions where the tip ends of the upper and lower rods 3 and 4 come closest to the molding groove 6 (compression molding positions, compression molding completion positions) so that the upper and lower pressing surfaces 13 and 14 and the molding groove 6 are seamlessly connected to each other to form a single, continuous, elliptically curved surface in cross-sectional side view, thereby compressing the powder 12 in the space S into the solid tablet 11 that has a circular shape in plan view and an elliptical shape in side view. In short, the pressing surfaces 13 and 14 and the molding groove 6 forms the surface of the tablet 11 by compression.

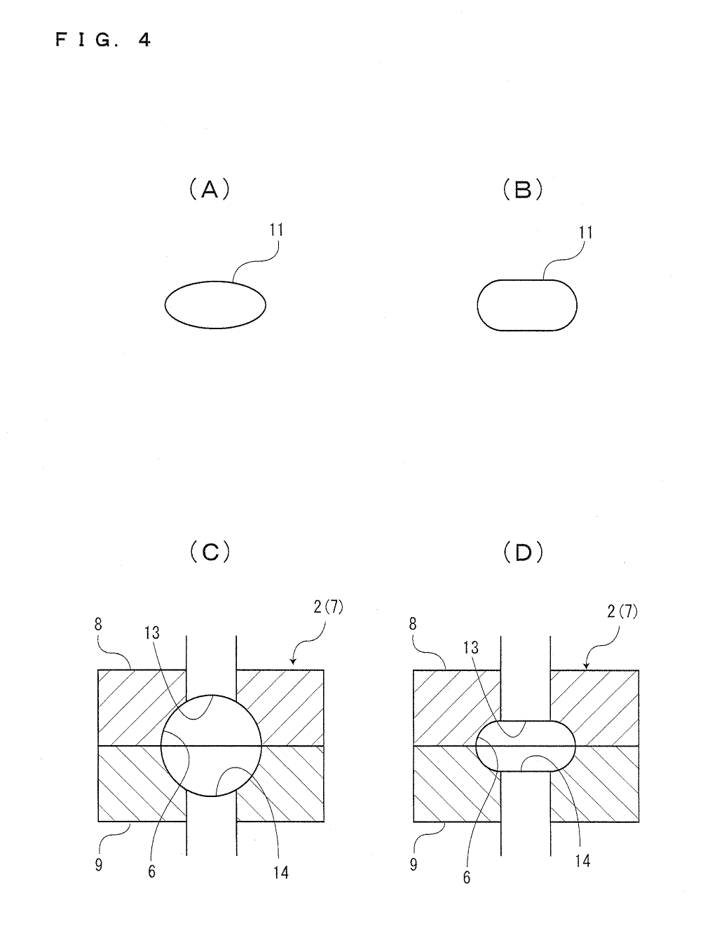

FIGS. 4(A) and 4(B) are plan views of tablets having different shapes. FIGS. 4(C) and 4(D) are cross-sectional side view of essential parts of tablet compression apparatuses that differ from the above-described tablet compression apparatus in shape of the molding groove and the pressing surface. Although the tablet 11 has been described as having a circular shape in plan view in the above example, the space S and the molding groove 6 may have an elliptical shape in plan view to mold a tablet 11 by compression into an elliptical shape in plan view (see FIG. 4(A)). Alternatively, the space S and the molding groove 6 may have an elongated circular shape (rounded rectangular shape) in plan view to mold a tablet 11 by compression into an elongated circular shape in plan view (see FIG. 4(B)).

Alternatively, the curvatures of the molding groove 6 and the pressing surfaces 13 and 14 may be modified so that the molding groove 6 and the pair of pressing surfaces 13 and 14 seamlessly connected each other at the time of completion of tablet compression 11 (at the time of molding of the tablet 11) form a circular shape in side view rather than the elliptical shape described above (see FIG. 4(C)). Alternatively, the curvature of the molding groove 6 may be modified and the pressing surfaces 13 and 14 may be flattened so that the molding groove 6 and the pair of pressing surfaces 13 and 14 seamlessly connected each other at the time of completion of tablet compression 11 form an elongated circular shape (rounded rectangular shape) in side view (see FIG. 4(D)).

In the example shown in FIG. 3, the molding groove 6 and the pair of pressing surfaces 13 and 14 seamlessly connected to each other at the time of completion of tablet compression molding of the tablet 11 form an elliptical shape having a longitudinal axis oriented perpendicularly to the axial direction of the space S in side view. However, the curvatures of the molding groove 6 and the pressing surfaces 13 and 14 may be modified so that the molding groove 6 and the pressing surfaces 13 and 14 form an elliptical shape having a longitudinal axis oriented in the same direction as the axial direction of the space S in side view.

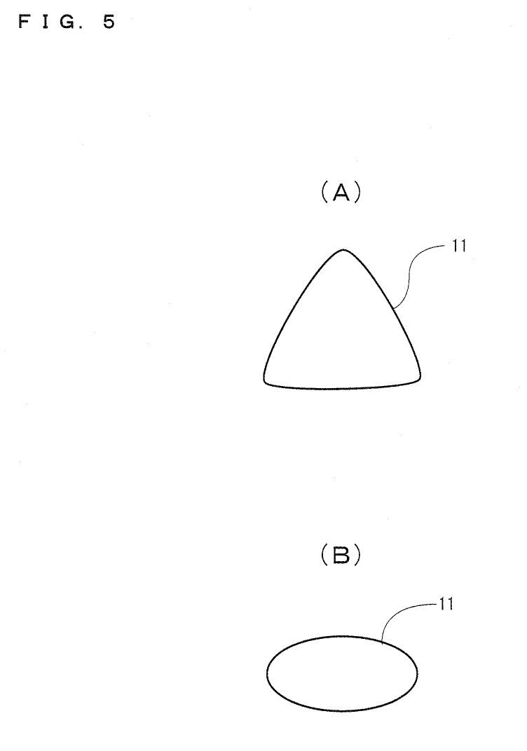

FIGS. 5(A) and 5(B) are a plan view and a side view of a tablet having a different shape. In the example shown in these drawings, the shape of the space S and the molding groove 6 in plan view is modified so that the tablet 11 molded by compression has a rounded triangular shape (a rounded triangular rice-ball shape) in plan view (see FIG. 5(A)), and the curvatures of the molding groove 6 and the pressing surfaces 13 and 14 are modified so that the molding groove 6 and the pair of pressing surfaces 13 and 14 seamlessly connected to each other at the time of completion of tablet compression 11 form an elliptical shape having a longitudinal axis oriented in the same direction as or perpendicularly to the axial direction of the space S in side view (see FIG. 5(B), which shows an example in which the longitudinal axis is oriented perpendicularly to the axial direction of the space S). The tablet 11 can have various other rounded polygonal shapes or curved shapes.

FIGS. 6(A) to 6(M) are state transition diagrams illustrating a process of molding a solid tablet by compression and removing the tablet by lifting or lowering the upper and lower rods and the lower die with the upper die fixed. First, the lower die 9 is moved upward (lifted or lifted up) to bring the lower die 9 into contact with the upper die 8 to form the die 2, the upper rod 3 is moved upward from the space S to open the upper end of the space S, and the lower rod 4 is moved upward and inserted into the space S from below to close the lower end of the space S (see FIG. 6(A)).

Then, the powder 12 is charged into the space S from above until the space S overflows with the powder 12 (see FIG. 6(B)). Then, the lower rod 4 is moved upward or downward (upward in the shown example) to adjust the amount of the powder 12 in the space S (see FIG. 6(C)). Then, a level-off step is performed to scrape off (sweep out) the heap of powder 12 over the space S with a scraper (scraping tool or sweeping tool) 16 or the like that moves leftward and rightward (see FIG. 6(D)).

Then, the upper rod 3 is inserted into the space S from above and moved downward (lowered or lowered down) to close the upper end of the space S (see FIG. 6(E)). Then, the upper rod 3 is moved downward, and the lower rod 4 is moved upward to the compression molding position to press the powder 12 (see FIG. 6(F)). Then, the upper rod 3 is moved downward to the compression molding position to compress the powder 12 into the solid tablet 11 (see FIG. 6(G)). At this time, the perimeter of the tablet 11 is engaged with and held by the annular molding groove 6.

To disengage and remove the tablet 11 from the die 2, first, the upper and lower rods 3 and 4 and the lower die 9 are moved together downward to separate the tablet 11 from the upper die 8 (see FIG. 6(H)). Then, the lower rod 4 and the lower die 9 are moved together downward to separate the tablet 11 from the upper rod 3 (see FIG. 6(I)). Then, the lower die 9 is moved downward to separate the lower die 9 from the tablet 11, and the upper rod 3 is moved upward (see FIG. 6(J)).

Then, using a removal plate (removal tool) 17 or the like that moves leftward and rightward, the tablet 11 placed on the lower rod 4 is discharged and removed from the tablet compression apparatus (see FIG. 6(K)). Then, the upper rod 3 is moved upward and separated from the upper die 8 (see FIG. 6(L)), and then, the upper and lower rods 3 and 4 and the lower die 9 are moved upward (see FIG. 6(M)) to restore the tablet compression apparatus to the state shown in FIG. 6(A). Then, the process shown in FIGS. 6(A) to 6(M) is repeated to successively mold the solid tablets 11 by compression and remove the solid tablets 11.

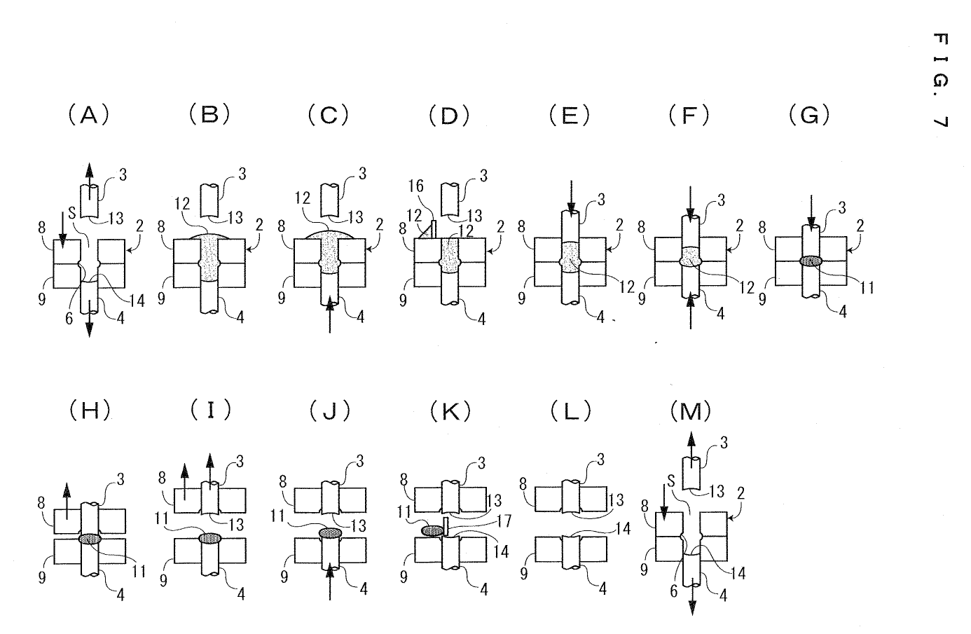

FIGS. 7(A) to 7(M) are state transition diagrams illustrating a process of molding a solid tablet by compression and removing the tablet by lifting or lowering the upper and lower rods and the upper die with the lower die fixed. First, the upper rod 3 is moved upward, and the lower rod 4 and the upper die 8 are moved downward to bring the upper die 8 into contact with the lower die 9 to form the die 2, and the upper rod 3 is displaced upward from the space S to open the upper end of the space S, and the lower rod 4 is inserted in the space S from below to close the lower end of the space S (see FIG. 7(A)).

Then, the powder 12 is charged into the space S from above until the space S overflows with the powder 12 (see FIG. 7(B)). Then, the lower rod 4 is moved upward or downward (upward in the shown example) to adjust the amount of the powder 12 in the space S (see FIG. 7(C)). Then, the level-off step is performed (see FIG. 7(D)).

Then, the upper rod 3 is inserted into the space S from above and moved downward (lowered or lowered down) to close the upper end of the space S (see FIG. 7(E)). Then, the upper rod 3 is moved downward, and the lower rod 4 is moved upward to the compression molding position to press the powder 12 (see FIG. 7(F)). Then, the upper rod 3 is moved downward to the compression molding position to compress the powder 12 into the solid tablet 11 (see FIG. 7(G)). At this time, the perimeter of the tablet 11 is engaged with and held by the annular molding groove 6.

To disengage and remove the tablet 11 from the die 2, first, the upper die 8 is moved upward to separate the upper die 8 from the tablet 11 (see FIG. 7(H)). Then, the upper rod 3 and the upper die 8 are moved together upward to separate the upper rod 3 from the tablet 11 (see FIG. 7(I)). Then, the lower rod 4 is moved upward to separate the tablet 11 from the lower die 9 (see FIG. 7(J)).

Then, using the removal plate 17 or the like that moves leftward and rightward, the tablet 11 placed on the lower rod 4 is discharged and removed from the tablet compression apparatus (see FIGS. 7(K) and (L)). Then, the upper rod 3 is moved upward, and the lower rod 4 and the upper die 8 are moved downward to restore the tablet compression apparatus to the state shown in FIG. 7(A). Then, the process shown in FIGS. 7(A) to 7(M) is repeated to successively mold the solid tablets 11 by compression and remove the solid tablets 11.

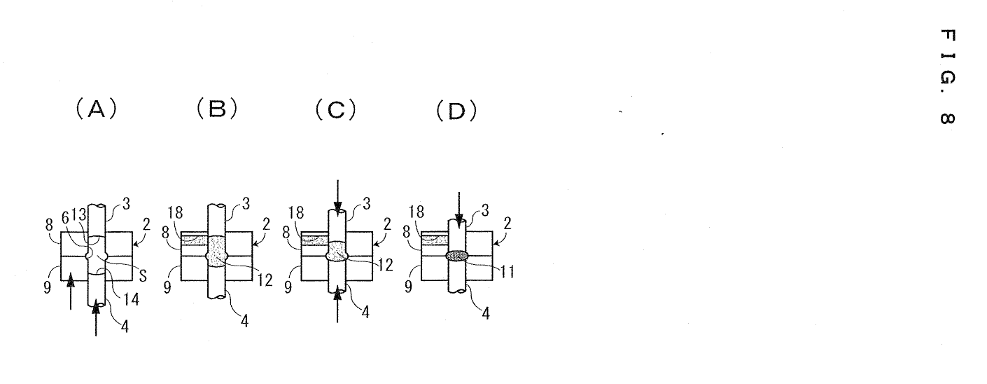

FIGS. 8(A) to 8(D) are state transition diagrams illustrating a process of molding a tablet by compression by charging powder into the space with the upper and lower ends of the space closed with the pair of upper and lower rods, respectively. First, the lower rod 4 and the lower die 9 is moved upward to bring the lower die 9 into contact with the upper die 8 to form the die 2 and to close the upper and lower ends of the space S with the upper and lower rods 3 and 4 (see FIG. 8(A)).

Then, the die 2 is horizontally rotated about a support shaft outside the die 2 (not shown) to produce a centrifugal force, by the action of which the powder 12 is charged into the space S from outside the die 2 through a horizontal supply hole (supply part) 18 that connects the outside of the die 2 and the inside of the space S to each other. As required, the lower rod 4 is moved upward or downward to adjust the volume (the amount of the powder 12) in the space S (see FIG. 8(B)). Then, the upper rod 3 is moved downward, and the lower rod 4 is moved upward to the compression molding position to press the powder 12 (see FIG. 8(C)). Then, the upper rod 3 is moved downward to the compression molding position to compress the powder 12 into the solid tablet 11 (see FIG. 8(D)). At this time, the perimeter of the tablet 11 is engaged with and held by the annular molding groove 6.

Then, the upper and lower rods 3 and 4 and the lower die 9 are moved upward or downward as shown in FIGS. 6(H) to 6(K) so that the tablet 11 can be removed, the upper die 8 and the lower die 9 are separated from each other with the upper rod 3 inserted in the upper die 8. Then, the lower rod 4 and the lower die 9 are moved upward to restore the tablet compression apparatus to the state shown in FIG. 8(A).

Next, other embodiments of the present invention will be described with regard to differences from the embodiment described above.

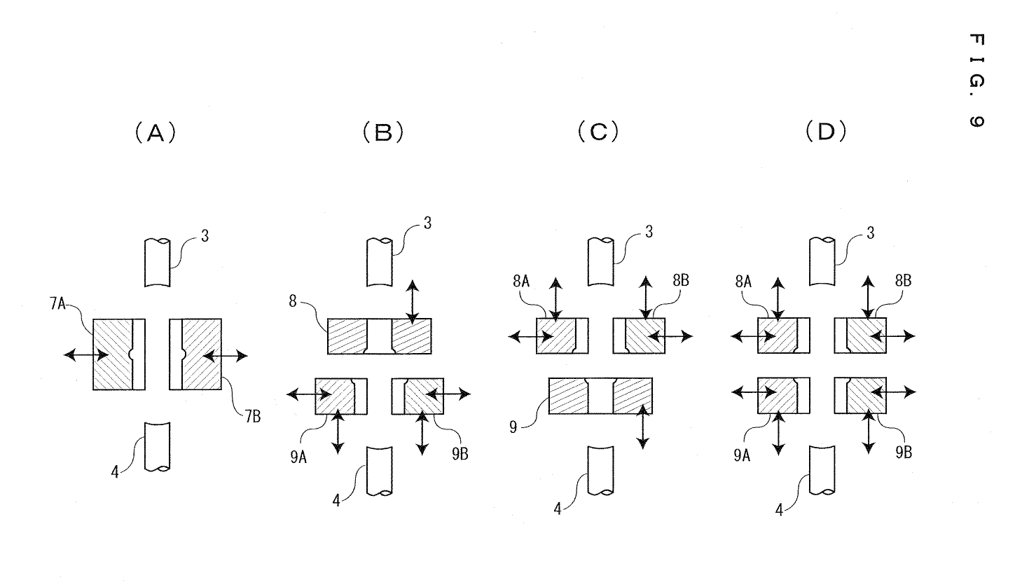

FIGS. 9(A) to 9(D) are cross-sectional side views of essential parts of tablet compression apparatuses according to other embodiments of the present invention. As shown in FIG. 9(A), there is provided a separation mechanism that separates the die main body 7 constituting the die 2 at a vertical division plane (division plane) M₂ (see FIG. 1(A)) that extends in the axial direction of the rods 3 and 4 and equally divides the molding groove 6.

In the example shown in FIG. 1(A), the vertical division plane M₂ extends in the axial direction (vertical direction) and the back-and-forth direction of the rods 3 and 4, and a pair of die divisions 7A and 7B resulting from the division at the vertical division plane M₂ are moved in directions away from and closer to each other (leftward and rightward in the example shown in FIG. 9(A)).

FIG. 9(B) shows an example of the separation mechanism that vertically separates the die main body 7 into the upper die 8 and the lower die 9 at the horizontal division plane M₁ and separates the lower die 9 into a pair of lower die divisions 9A and 9B at the vertical division plane M₂. The pair of lower die divisions 9A and 9B are moved not only in the directions away from and closer to each other but also vertically.

FIG. 9(C) shows an example of the separation mechanism that vertically separates the die main body 7 into the upper die 8 and the lower die 9 at the horizontal division plane M₁ and separates the upper die 8 into a pair of upper die divisions 8A and 8B at the vertical division plane M₂. The pair of upper die divisions 8A and 8B are moved not only in the directions away from and closer to each other but also vertically.

FIG. 9(D) shows an example of the separation mechanism that vertically separates the die main body 7 into the upper die 8 and the lower die 9 at the horizontal division plane M₁ and separates the upper die 8 and the lower die 9 into a pair of upper die divisions 8A and 8B and a pair of lower die divisions 9A and 9B, respectively, at the vertical division plane M₂. The pair of upper die divisions 8A and 8B and the pair of lower die divisions 9A and 9B are moved not only in the directions away from and closer to each other but also vertically.

Next, another embodiment of the present invention will be described with regard to differences from the embodiments described above.

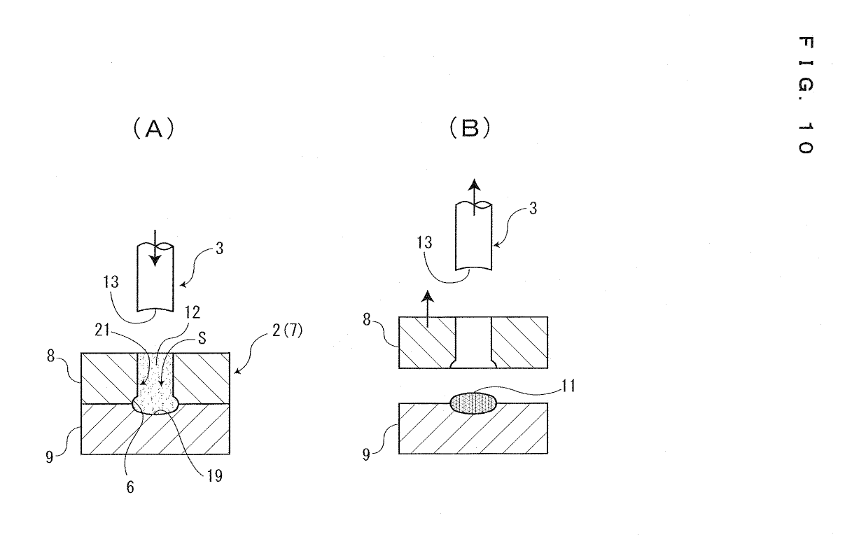

FIGS. 10(A) and 10(B) are a cross-sectional side view and an exploded cross-sectional side view of essential parts of a tablet compression apparatus according to another embodiment of the present invention, respectively. With the tablet compression apparatus, a vertical cylindrical die hole 21 is formed in an upper part of the die 2. The vertical cylindrical die hole 21 is open at the upper end and is defined at the lower end by a curved bottom surface (closed surface) 19 that is concave toward the center thereof. The inside of the die hole 21 provides the space S described above.

A circular ring-shaped molding groove 6 that is seamlessly connected to the bottom surface 19 is formed in the inner circumference of the space S along the entire perimeter thereof at which the inner circumference of the space S connects to the bottom surface 19. The upper rod 3, which extends in the axial direction of the die hole 21 and is arranged coaxially with the die hole 21, is inserted into the space S through the open end. When the tip end of the upper rod 3 is moved downward to the compression molding position in the space S, the molding groove 6, the pressing surface 13 at the tip end of the upper rod 3 and the bottom surface 19 are seamlessly connected to each other to form an elliptical shape in cross-sectional side view, and compress the powder 12 in the space S into the solid tablet 11 having an elliptical shape in side view and a circular shape in plan view. That is, the molding groove 6, the pressing surface 13 of the upper rod 3 and the bottom surface 19 cooperate to form the surface of the tablet 11 by compression.

The die main body 7 constituting the die 2 has the separation mechanism that vertically separates the die main body 7 into upper and lower parts at the horizontal division plane M₁, the upper part constitutes the upper die 8, and the lower part constitutes the lower die 9. The shape of the tablet 11 can be modified as shown in FIGS. 4 and 5 by appropriately modifying the shapes of the molding groove 6, the bottom surface 19 and the pressing surface 13 of the upper rod 3 as described above.

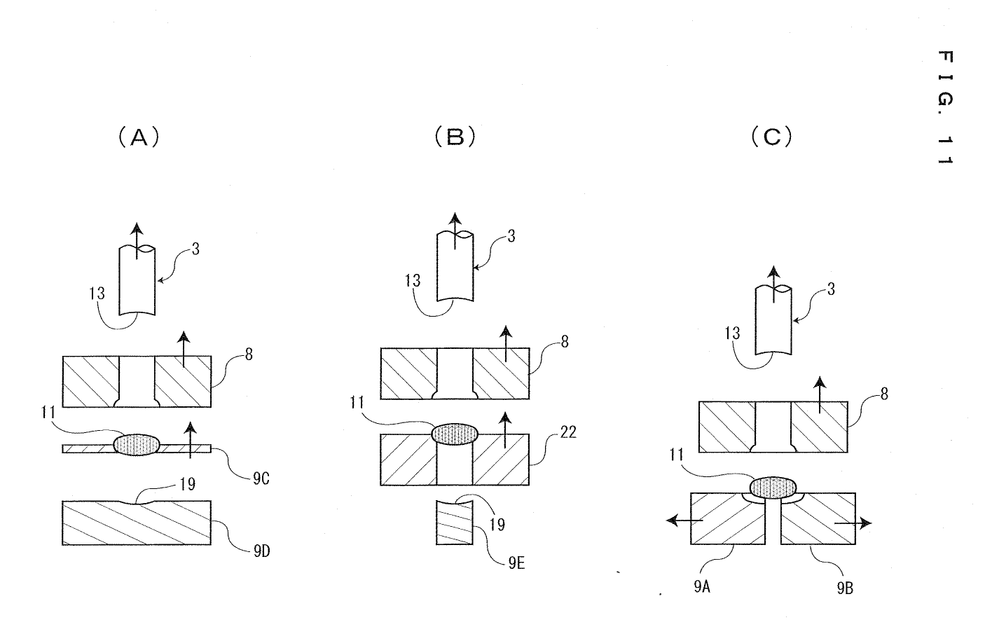

FIGS. 11(A) to 11(C) are exploded cross-sectional side views of modifications of the tablet compression apparatus shown in FIG. 10. FIG. 11(A) shows an example in which the lower die 9 is vertically divided into a molding groove-side lower die piece 9C that includes a part of the molding groove 6 and a bottom surface-side lower die piece 9D that includes the bottom surface 19. The molding groove-side lower die piece 9C is moved upward to separate the molding groove-side lower die piece 9C from the bottom surface-side lower die piece 9D, thereby separating the tablet 11 from the bottom surface 19 and facilitating removal of the tablet 11.

FIG. 11(B) shows an example in which a cylindrical piece 9E is hollowed out of the lower die 9 from below in such a manner that the cylindrical piece 9E includes the bottom surface 19, and the cylindrical piece 9E is separated from a main body 22 of the lower die 9 to separate the tablet 11 from the bottom surface 19. The main body 22 of the lower die 9 is moved upward or downward to separate or couple the main body 22 from or to the cylindrical piece 9E.

FIG. 11(C) shows an example in which the lower die 9 is divided into the pair of lower die divisions 9A and 9B at the vertical division plane M₂. The pair of lower die divisions 9A and 9B are moved in the directions away from and closer to each other, and thus, the tablet 11 on the bottom surface 19 can be easily separated from the bottom surface 19.

Next, another embodiment of the present invention will be described with regard to differences from the embodiments described above.

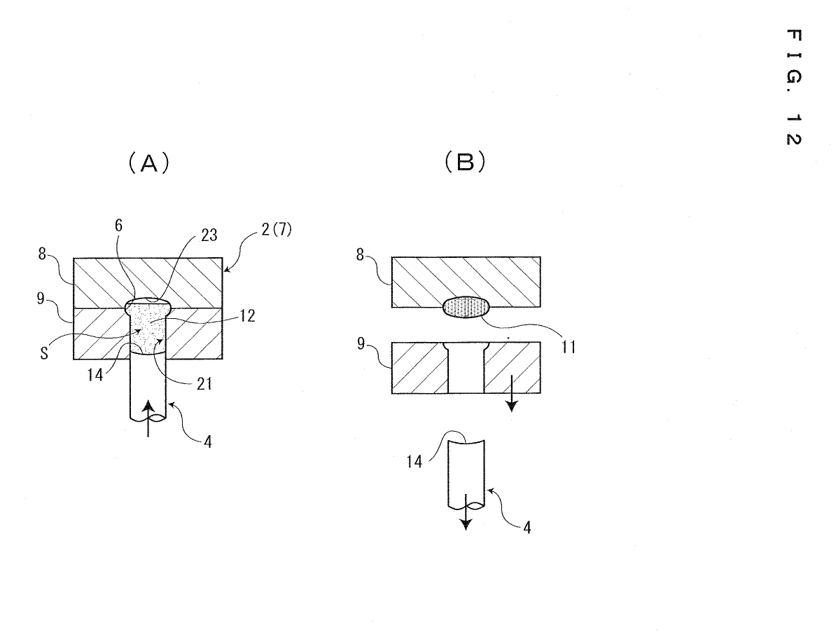

FIGS. 12(A) and 12(B) are a cross-sectional side view and an exploded cross-sectional front view of essential parts of a tablet compression apparatus according to another embodiment of the present invention, respectively. With the tablet compression apparatus, a vertical cylindrical die hole 21 is formed in a lower part of the die 2. The vertical cylindrical die hole 21 is open at the lower end and is defined at the upper end by a curved top surface (closed surface) 23 that is concave toward the center thereof. The inside of the die hole 21 provides the space S described above.

A circular ring-shaped molding groove 6 that is seamlessly connected to the top surface 23 is formed in the inner circumference of the space S along the entire perimeter thereof at which the inner circumference of the space S connects to the top surface 23. The lower rod 4, which extends in the axial direction of the die hole 21 and is arranged coaxially with the die hole 21, is inserted into the space S through the open end when the space S is charged with a required amount of powder 12. When the tip end of the lower rod 4 is moved upward to the compression molding position in the space S, the molding groove 6, the pressing surface 14 at the tip end of the lower rod 4 and the top surface 23 are seamlessly connected to each other to form an elliptical shape in cross-sectional side view, and compress the powder 12 in the space S into the solid tablet 11 having an elliptical shape in side view and a circular shape in plan view. That is, the molding groove 6, the pressing surface 14 of the lower rod 4 and the top surface 23 cooperate to form the surface of the tablet 11 by compression.

The die main body 7 constituting the die 2 has the separation mechanism that vertically separates the die main body 7 into upper and lower parts at the horizontal division plane M₁, the upper part constitutes the upper die 8, and the lower part constitutes the lower die 9. The shape of the tablet 11 can be modified as shown in FIGS. 4 and 5 by appropriately modifying the shapes of the molding groove 6, the top surface 23 and the pressing surface 14 of the lower rod 4 as described above.

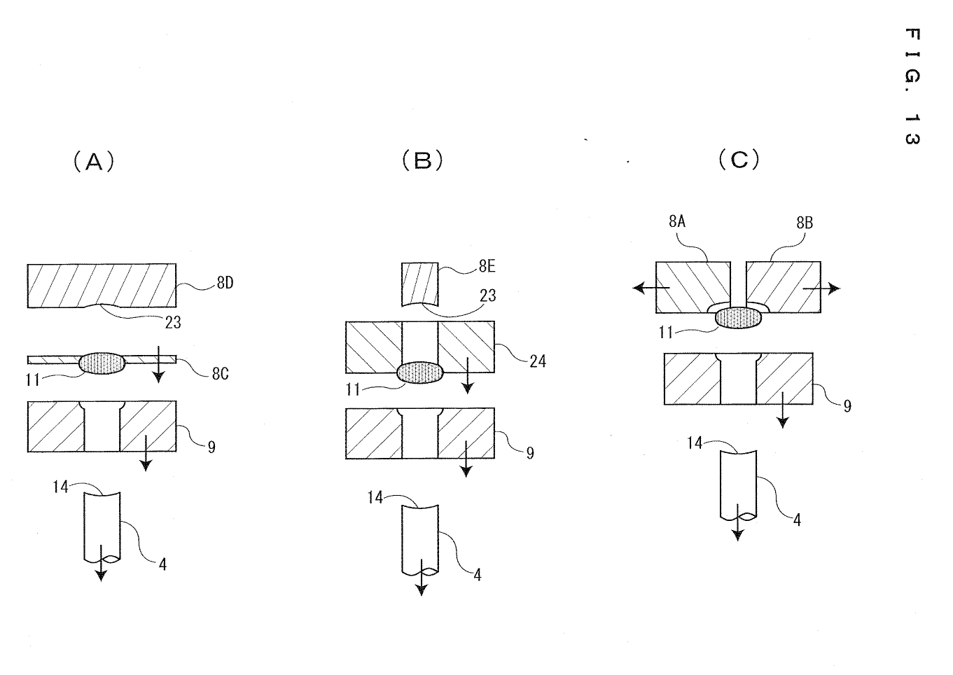

FIGS. 13(A) to 13(C) are exploded cross-sectional side views of modifications of the tablet compression apparatus shown in FIG. 12. FIG. 13(A) shows an example in which the upper die 8 is vertically divided into a molding groove-side upper die piece 8C that includes a part of the molding groove 6 and a top surface-side upper die piece 8D that includes the top surface 23. The molding groove-side upper die piece 8C is moved downward to separate the molding groove-side upper die piece 8C from the top surface-side upper die piece 8D, thereby separating the tablet 11 from the top surface 23 and facilitating removal of the tablet 11.

FIG. 13(B) shows an example in which a cylindrical piece 8E is hollowed out of the upper die 8 from above in such a manner that the cylindrical piece 8E includes the top surface 23, and the cylindrical piece 8E is separated from a main body 24 of the upper die 8 to separate the tablet 11 from the bottom surface 19. The main body 24 of the upper die 8 is moved upward or downward to couple or separate the cylindrical piece 8E and the main body 24 to or from each other.

FIG. 13(C) shows an example in which the upper die 8 is divided into the pair of upper die divisions 8A and 8B at the vertical division plane M₂. The pair of upper die divisions 8A and 8B are moved in the directions away from and closer to each other, and thus, the tablet 11 on the top surface 23 can be easily separated from the top surface 23.

1. A tablet compression die having a space (S) extending in an axial direction of rods (3) and (4) into which the rods are inserted, the rods (3) and (4) having pressing surfaces (13) and (14) at a tip end, respectively, and said pressing surfaces (13) and (14) the powder (12) in the space (S) into a solid tablet (11) by compression,
wherein an annular concave molding groove (6), which is seamlessly connected to said pressing surfaces (13) and (14) to form a part of the surface of the tablet (11) during tableting, is formed in an inner circumference of the space (S), and
the tablet compression die has a separation mechanism that separates at least a part of a die main body (7) to allow removal of the tablet (11) held in the annular molding groove (6).

2. The tablet compression die according to claim 1, wherein the tablet compression die has a die cavity (1) whose inside provides the space (S) and that is open at opposite ends and extends in the axial direction of the rods (3) and (4) to allow insertion of the pair of rods (3) and (4) through the opposite open ends, and the pressing surfaces (13) and (14) of the pair of rods (3) and (4) and said molding groove (6) are seamlessly connected to each other to form a single circular, elliptical or elongated circular shape in cross-sectional side view during tableting.

3. The tablet compression die according to claim 1, wherein the tablet compression die has a die hole (21) whose inside provides the space (S) and that is open at one end to allow insertion of the rod (3) or (4) and defined at the other end by a closed surface (19) or (23) and extends in the axial direction of the rods (3) and (4), and said closed surface (19) or (23), the pressing surface (13) or (14) and the molding groove (6) are seamlessly connected to each other to form a single circular, elliptical or elongated circular shape in cross-sectional side view during tableting.

4. The tablet compression die according to claim 1, wherein the separation mechanism separates the die main body (7) at a plane that extends in the axial directions of the rods (3) and (4) and divides the molding groove (6).

5. The tablet compression die according to claim 1, wherein the separation mechanism separates the die main body (7) at a plane that extends in a direction perpendicular to the axial directions of the rods (3) and (4) and divides the molding groove (6).

6. The tablet compression die according to claim 2, wherein the separation mechanism separates the die main body (7) at a plane that extends in the axial directions of the rods (3) and (4) and divides the molding groove (6).

7. The tablet compression die according to claim 3, wherein the separation mechanism separates the die main body (7) at a plane that extends in the axial directions of the rods (3) and (4) and divides the molding groove (6).

8. The tablet compression die according to claim 2, wherein the separation mechanism separates the die main body (7) at a plane that extends in a direction perpendicular to the axial directions of the rods (3) and (4) and divides the molding groove (6).

9. The tablet compression die according to claim 3, wherein the separation mechanism separates the die main body (7) at a plane that extends in a direction perpendicular to the axial directions of the rods (3) and (4) and divides the molding groove (6).

10. The tablet compression die according to claim 4, wherein the separation mechanism separates the die main body (7) at a plane that extends in a direction perpendicular to the axial directions of the rods (3) and (4) and divides the molding groove (6).

11. The tablet compression die according to claim 6, wherein the separation mechanism separates the die main body (7) at a plane that extends in a direction perpendicular to the axial directions of the rods (3) and (4) and divides the molding groove (6).

12. The tablet compression die according to claim 7, wherein the separation mechanism separates the die main body (7) at a plane that extends in a direction perpendicular to the axial directions of the rods (3) and (4) and divides the molding groove (6).
